(19) United States
(12) Patent Application Publication
(10) Pub. No.: US 2011/0295609 A1
(43) Pub. Date: Dec. 1, 2011

(54) ITEMIZING POLLUTANTS OF ACTIVITIES

(75) Inventors: Janne M.P. Koponen, Buckinghamshire (GB); Peter J. Gilbert, New Jersey, NJ (US); Terrence G. Clark, Smithtown, NY (US); James B. Mercer, Millville, MA (US)

(73) Assignee: COMPUTER ASSOCIATES THINK, INC., Islandia, NY (US)

(21) Appl. No.: 12/790,224

(22) Filed: May 28, 2010

(51) Int. Cl. G06Q 10/00

(52) U.S. Cl. 705/1.1

(57) ABSTRACT

According to one embodiment of the present invention, a method for itemizing pollutants of activities may be provided. The method may include receiving a first quantity of an activity that indicates an amount of the activity that is performed. The method may further include accessing a list of one or more pollutants that are released when the activity is performed. One or more pollutant factors may be selected. Each pollutant factor may be associated with a pollutant of the one or more pollutants and may indicate an amount of the associated pollutant released when the activity is performed. One or more pollutant quantities of the one or more pollutants may be calculated according to the first quantity of the performed activity and the pollutant factor associated with the pollutant. The method may also include facilitating display of the one or more pollutant quantities.

### TECHNICAL FIELD

This invention relates generally to the field of pollutant reporting and more specifically to itemizing pollutants of activities.

### BACKGROUND

An organization may participate in activities that release pollutants and may utilize a computerized system to track and/or estimate the release of pollutants.

### SUMMARY OF THE DISCLOSURE

In accordance with the present invention, disadvantages and problems associated with previous techniques for tracking pollutants may be reduced or eliminated.

According to one embodiment of the present invention, a method for itemizing pollutants of activities may be provided. The method may include receiving a first quantity of an activity that indicates an amount of the activity that is performed. The method may further include accessing a list of one or more pollutants that are released when the activity is performed. One or more pollutant factors may be selected. Each pollutant factor may be associated with a pollutant of the one or more pollutants and may indicate an amount of the associated pollutant released when the activity is performed.

One or more pollutant quantities of the one or more pollutants may be calculated according to the first quantity of the performed activity and the pollutant factor associated with the pollutant. The method may also include facilitating display of the one or more pollutant quantities.

Certain embodiments of the invention may provide one or more technical advantages. A technical advantage of one embodiment may be that pollutants of one or more activities may be itemized and reported. Another technical advantage of one embodiment may be that an organization may track and/or estimate pollutants released by the activities.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts an example of a system for itemizing pollutants of various activities;

FIGS. 2A-2D depict examples of pollutant reports that may be generated by the system of FIG. 1; and

FIG. 3 depicts an example of a method for itemizing pollutants of various activities.

### DETAILED DESCRIPTION OF THE DRAWINGS

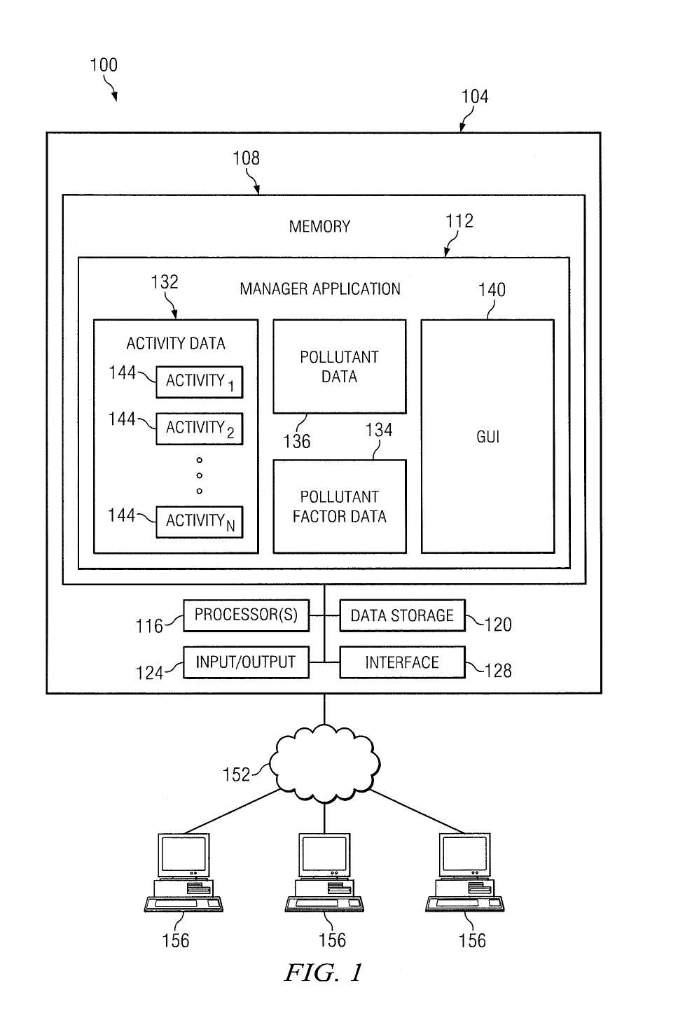

Embodiments of the present invention and its advantages are best understood by referring to FIGS. 1-3 of the drawings, like numerals being used for like and corresponding parts of the various drawings.

FIG. 1 depicts an example of a system 100 for itemizing pollutants of various activities. The system may include a manager application 112 that is operable to receive a first quantity of an activity that indicates an amount of the activity that is performed. The manager application 112 may access a list of one or more pollutants that are released when the activity is performed. The manager application 112 may also select one or more pollutant factors that are each associated with a pollutant of the one or more pollutants. These pollutant factors may indicate an amount of the associated pollutant released when the activity is performed. The manager application 112 may calculate one or more pollutant quantities of the one or more pollutants according to the first quantity of the performed activity and the pollutant factor associated with the pollutant. The manager application 112 may also facilitate display of the one or more pollutant quantities.

In the depicted embodiment, system 100 includes computing system 104, computing systems 156, and network 152 coupled as shown. Network 152 may comprise any wireless and/or wired network that enables communication between computing systems 104 and 156. Computing system 104 may include memory 108, one or more processors 116, data storage 120, input and/or output devices 124, and interface 128. Computing systems 156 may include similar components.

Memory 108 and/or data storage 120 may comprise any hardware, software, firmware, or combination thereof operable to facilitate storage and retrieval of information. Input and/or output devices 124 may facilitate communication between computing systems 104 and 156 and/or within a particular computing system 104 or 156. Interface 128 may comprise any device that may be used to communicate with a particular computing system 104 or 156.

In the depicted embodiment, memory 108 includes a manager application 112 that includes activity data 132, pollutant data 136, pollutant factor data 134, and a graphical user interface (GUI) 140. Manager application 112 may use data 132-136 and GUI 140 to help an organization track and/or estimate characteristics of the organization's activities. For example, in certain embodiments, activities of the organization may release pollutants or other substances. The organization may desire to track these pollutants in order to gauge and/or facilitate compliance with pollution laws, cost, environmental impact, and/or other factors. In some embodiments, manager application 112 may be operable to itemize pollutants of various activities, that is, the manager application 112 may calculate pollutant quantities of individual pollutants released by one or more activities. The manager application may be operable to report the itemized pollutants to a user of a computing system 104 or 156.

In some embodiments, manager application 112 may be accessed by a user of a computing system 104 or 156 of system 100. In some embodiments, all or a portion of manager application 112 may reside at any suitable location, such as memory 108, external to memory 108, and/or external to computing system 104.

In the depicted embodiment, manager application 112 includes activity data 132. In some embodiments, activity data 132 may include information about activities associated with an organization. In some embodiments, an activity may be an act performed (directly or indirectly) or contemplated by the organization. An activity may be described by an activity type, such as coal burning, heat generation, grid electricity consumption, product manufacture, air travel, or other suitable act. In some embodiments, an activity may be associated with a category, such as electricity generation, electricity consumption, travel, manufacturing, fuel burning, shipping, or other suitable category. In some embodiments, activity data 132 may include activity objects 144 that are each associated with an activity of the organization. In some embodiments, information about an activity may be included in the activity object 144 associated with the activity.

In some embodiments, activity data 132 may include a list for each activity that indicates a set of pollutants released when the activity is performed. As an example, an activity object 144 may be associated with “shipping freight by truck” and include a list of pollutants comprising “carbon dioxide,” “methane,” and “nitrous oxide.” In some embodiments, an activity object 144 may comprise a set of subobjects that are each associated with a pollutant released by the activity associated with activity object 144.

In various embodiments, activity data 132 may also include one or more units associated with an activity, a category of an activity, and/or a quantity of the activity performed. In some embodiments, a unit of an activity may be used to expressed a quantity of the activity. For example, a quantity of an activity of the “electricity consumption” category may be expressed in kilowatt-hours and a quantity of an activity of the “long haul air travel” category may be expressed in miles.

In some embodiments, activity data 132 may include other information associated with an activity, such as the date and/or time a quantity of an activity was performed, the cost of performance, the location of the performance, a description of the activity, documentation of the activity, and/or other information. In some embodiments, some or all of this information may be recorded in an activity object 144. For example, an activity object 144 associated with “consumption of natural gas” may include attributes specifying a quantity of natural gas consumed, where the consumption took place, and when the consumption occurred.

In some embodiments, activity data 132 may be logically linked to pollutant data 136 of manager application 112. Pollutant data 132 may comprise a set of pollutants tracked by an organization. A pollutant may be any substance (such as a contaminating waste material) produced and/or released by an activity. As used herein, a release of a pollutant may refer to a direct or indirect release of a pollutant from an activity. For example, “grid electricity consumption” may not directly release a pollutant, but may indirectly release a pollutant since a pollutant may be released during generation of the electricity consumed. In some embodiments, a pollutant may be described by a pollutant type, such as a greenhouse gas (such as carbon dioxide, methane, nitrous oxide, sulfur hexafluoride, a hydrofluorocarbon, a perfluorocarbon, or other greenhouse gas), carbon monoxide, or other substance released directly or as a result of an activity.

In some embodiments, pollutant data 136 may include one or more pollutant factors, such as a global warming potential (GWP) of a pollutant. A GWP is a factor that is used to convert an amount of non-carbon dioxide emissions to a carbon dioxide equivalent (CO2e) amount of emissions. For example, if the GWP of methane is 21, then releasing 1 kilogram of methane may have the same effect as releasing 21 kilograms of carbon dioxide. In some embodiments, a GWP may be expressed as a CO2e of a pollutant per a unit of the pollutant, such as mass or other unit.

In some embodiments, pollutant data 136 may comprise other information about one or more pollutants, such as a chemical formula, category, description, or time horizon of a pollutant, the origin of the GWP of a pollutant, the time of update of pollutant data 136, the identity of an updater of pollutant data 136, and/or any other suitable information.

In some embodiments, activity data 132 and/or pollutant data 136 may be logically linked to pollutant factor data 134. Pollutant factor data 134 may include one or more pollutant factors, such as an emission factor. In some embodiments, an emission factor may specify an amount of a pollutant that is released per a unit of an activity. In various embodiments, an emission factor may specify a mass of pollutant per unit of mass, volume, distance, or duration of the activity emitting the pollutant. For example, an emission factor may specify that 0.0015 kilograms of methane are released per mile for a certain class of vehicle or that 0.235 kilograms of carbon dioxide are released per kilowatt-hour of electricity consumed in a certain region. In some embodiments, once a mass of released pollutant has been determined, a GWP may be used to convert the amount of pollutant to a CO2e amount.

In some embodiments, an emission factor may specify a CO2e (rather than a mass) of a pollutant per a unit of an activity. That is, an emission factor may incorporate a GWP of a pollutant. Accordingly, in some embodiments, an emission factor can be used to directly convert a quantity of an activity to a CO2e value. As an example, an emission factor may specify that the methane released when one gallon of fuel oil is burned is equivalent to 0.021 metric tonnes of carbon dioxide. In some embodiments, an emission factor may state the aggregate CO2e of an activity. That is, the emission factor may include the sum of the CO2e amounts of each pollutant released by the activity.

In various embodiments, a pollutant factor may be associated with a location. For example, a pollutant factor may be associated with an address of a unit of the organization, a city, a county, a state, a country, a region, the whole world, or other suitable location. In some embodiments, these locations may form a hierarchy of levels. For example, an organization may have 175 facilities using natural gas in North America (a region) that can share the same pollutant factor based upon reliable information about commercial gas furnaces. Rather than tracking 175 separate records, the organization can set the appropriate pollutant factor once at the region level and use this pollutant factor for lower levels of the hierarchy. For example, in various embodiments, manager application 112 may be capable of automatically applying the recommended pollutant factor to all facilities within the region. Additionally, manager application 112 may enable a user to override this region-level pollutant factor setting. For example, if a particular facility uses a special type of furnace, a user may be given the option to override a region-based pollutant factor value by explicitly creating a pollutant factor for that facility. In some embodiments, manager application 112 may apply the most granular (i.e., lowest level) pollutant factor available to facilitate accurate calculation of pollutant quantities.

In some embodiments, pollutant factor data 134 may be designed to help an organization maintain critical data regarding pollutant factors. For example, system 100 may retain data about a pollutant factor (such as the time period relevant to the pollutant factor, a time-stamp of when the pollutant factor was last examined for accuracy, and/or the identity of the reviewer), the source from which the pollutant factor is derived, and/or may allow the user to attach related documentation.

Because pollutant factor data 134 may include information regarding the age of the underlying data, manager application 112 may be capable of using stale data thresholds to help avoid the use of out-of-date pollutant factors. For example, if the explicit pollutant factor for a Boston office of the organization has not been kept current and/or its review date is older than the user-specified stale data threshold, then manager application 112 may automatically look further up the hierarchy to locate a pollutant factor that is applicable to the Boston office.

Such a design may provide a variety of useful features. For example, the geographic hierarchy of some pollutant factors may enable users and/or manager application 112 to identify particular locations or regions that provide the cleanest energy. Additionally, pollutant factors that are out-of-date may be flagged for review by manager application 112. An organization may be allowed to set standards for how often pollutant factors should be reviewed. In some embodiments, manager application 112 may store pollutant factors used in calculating pollutant quantities, thus allowing for future review of these factors.

In some embodiments, activity data 132, pollutant data 136, and pollutant factor data 134 may be generated and modified by any suitable method. For example, data 132-136 may be obtained from a user (e.g., through GUI 140 or a command prompt), a sensor or meter, computing systems 104 or 156, a device of network 152, and/or other suitable sources. In some embodiments, manager application 112 may respond to a modification of data 132-136 by dynamically updating previously recorded data. For example, if underlying data, such as an activity quantity or pollutant factor is modified, the manager application 112 may update pollutant quantities accordingly. In some embodiments, all or a portion of data 132-136 may be stored in one or more objects, tables, or other suitable data structures.

In some embodiments, manager application 112 may include a GUI 140. The GUI 140 may facilitate user interaction with the manager application 112. In some embodiments, a user may use the GUI 140 to update activity data 132, pollutant data 136, and/or pollutant factor data 134. For example, a user may add and/or modify a quantity of an activity performed, add an activity, modify the set of pollutants released by an activity, modify or add an emission factor, modify a GWP, and/or perform other operations. In some embodiments, the manager application 112 may respond to such modifications by dynamically updating previously recorded data.

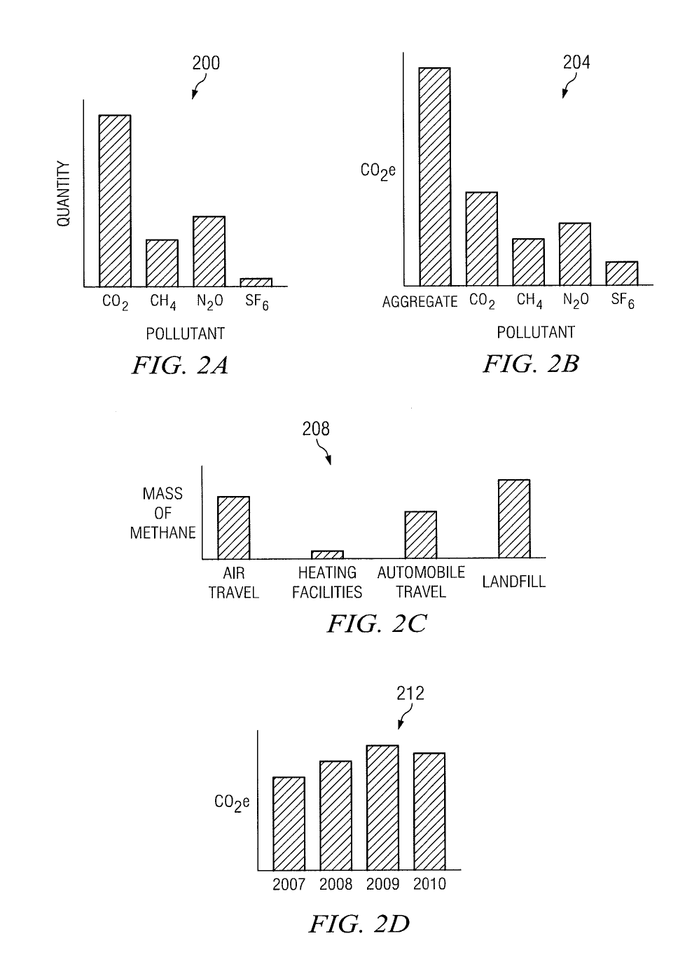

In some embodiments, a user may use the GUI 140 to request and/or view a report. A report may be a collection of information provided to a user. Examples of reports that may be produced by manager application 112 is described with reference to FIG. 2. A report may be provided to the user in a computer-displayable format (e.g., in a PDF format, through the GUI 140, as a text message, etc.), in a tangible format (e.g., a computer printout, a fax, etc.), and/or other suitable format. In some embodiments, manager application 112 may be capable of enabling a user to interface with a variety of GUIs 140 that report various pollutant-related information.

In some embodiments, manager application 112 may be operable to itemize pollutants released by an organization's activities. In some embodiments, manager application 112 may utilize activity data 132, pollutant data 136, pollutant factor data 134, and/or GUI 140 to facilitate calculation and reporting of the pollutant quantities.

In some embodiments, the manager application 112 may access a quantity of a performed activity. In various embodiments, the quantity of the performed activity may be stored in the activity object 144 associated with the performed activity or other suitable location of system 100. The manager application 112 may access activity data 132 to determine the pollutants released by the activity. For example, manager application 112 may access a list of one or more pollutants that are released when the activity is performed. The manager application 112 may also access pollutant factor data 134 and/or pollutant data 136 to retrieve one or more pollutant factors associated with these pollutants. In some embodiments, manager application 112 may select a pollutant factor for each pollutant. For example, the manager application 112 may select the newest available pollutant factor associated with the activity and the pollutant. As another example, the manager application 112 may select a pollutant factor that has the best location fit for the activity (i.e., most granular). The manager application 112 may use a quantity of the activity and the selected pollutant factor to calculate a pollutant quantity of the associated pollutant. For example, the manager application 112 may calculate a mass of the pollutant or the pollutant's CO2e. The manager application 112 may perform similar calculations for other pollutants released by the activity. In some embodiments, manager application 112 may calculate an aggregate CO2e of an activity by summing the CO2e values of each pollutant of an activity. The manager application 112 may store and/or report these results. In some embodiments, manager application 112 may store results (such as a pollutant quantity or a method used to calculate the pollutant quantity) associated with a particular pollutant in the corresponding subobject of the activity object 144 associated with the activity. In various embodiments, the manager application 112 may facilitate display of results to a user.

The manager application 112 may be operable to receive additional quantities of the activity and calculate itemized pollutants. For example, the manager application 112 may receive a quantity of an activity for which itemized pollutants have already been calculated and/or reported. The manager application 112 may be operable to use the received quantity and the previously received quantities to calculate aggregate pollutant quantities of the activity. For example, the manager application 112 may calculate a pollutant quantity using the additional quantity of the activity and add it to a pollutant quantity stored by a subobject (associated with the pollutant) of an activity object 144 associated with the activity. Furthermore, the manager application 112 may be operable to calculate itemized pollutant quantities released by a combination of different activities.

In some embodiments, the manager application 112 may account for portions of an activity that are not attributable to the organization. For example, the organization may be responsible for a portion (P) of a quantity of an activity, where P is expressed as a percentage of the quantity of the activity. The manager application may use P as part of a pollutant quantity calculation. For example, an organization may own 40% of a facility that emits 100 kilograms of carbon dioxide when a quantity of an activity is performed. Accordingly, the manager application 112 may determine that only 40 kilograms of the carbon dioxide released by the activity is attributable to the organization.

In some embodiments, manager application 112 may be operable to provide simulated pollutant quantities. For example, a user may enter predicted quantities of activities and the manager application 112 may predict pollutant quantities of one or more pollutants that will be released from the activities.

In some embodiments, manager application 112 may be operable to accept input regarding pollutant quantities and integrate this information with data of system 100. For example, if a pollutant quantity is measured by a sensor, this pollutant quantity may be used in place of a pollutant quantity calculated by the manager application 112.

In some embodiments, manager application 112 may store the methods used in each instance to calculate itemized pollutants and the results. For example, manager application 112 may store the activity quantities, pollutant factors, pollutant quantities, the formula used to calculate pollutant quantities, and/or other information associated with the calculation of itemized pollutants.

FIGS. 2A-2D depict examples of pollutant reports that may be generated by manager application 112. In some embodiments, a user may send a request to manager application 112 for a pollutant report of FIG. 2A. A user may request the report of FIG. 2A in any appropriate manner. For example, a user may use GUI 140 or a command prompt to send the request. The request may specify the information to be included in the report. The manager application 112 may be operable to produce a report of FIG. 2A based on the information requested. For example, a report of FIG. 2A may include itemized pollutants of one or more activities, one or more categories of activities, a time duration of one or more activities, a location of one or more activities, or other data associated with the activities, other characteristics associated with one or more activities, and/or a combination of the preceding.

For example, in the embodiment depicted, the report of FIG. 2A includes itemized pollutants comprising carbon dioxide, methane, nitrous oxide, and sulfur hexafluoride. The report of FIG. 2A indicates a quantity of each pollutant. In some embodiments, the report of FIG. 2A may be generated by manager application 112 after a request for itemized pollutants of an activity over a specified time period. For example, the report of FIG. 2A could show itemized pollutants released by a specific manufacturing process in 2009. In some embodiments, the report of FIG. 2A may be generated by manager application 112 after a request for itemized pollutants of more than one activity over a specified time span. For example, the report of FIG. 2A could indicate the pollutants released by all activities of the organization in the first quarter of 2010.

As another example, the report of FIG. 2B includes the same itemized pollutants expressed as CO2e values. Such a report may allow a user to analyze the carbon footprint of one or more activities of the organization. In some embodiments, a report of FIG. 2B may indicate the CO2e of each pollutant and/or the aggregate CO2e of the activity or group of activities over a specified timespan. As another example, a report of FIG. 2D may indicate an aggregate amount of CO2e released by an organization's activities in the years 2007, 2008, 2009, and 2010.

In some embodiments, the manager application 112 may be operable to generate a report that indicates a characteristic of one or more pollutants. For example, the report of FIG. 2C indicates an amount of methane released by various activities such as air travel, heating facilities, automobile travel, and landfill. In some embodiments, manager application 112 may be operable to generate similar reports for other characteristics of a pollutant or combination of pollutants, such as time frames of the release of the pollutant, locations of the release of the pollutant (e.g., plant, region, or organization), and/or other characteristics associated with the pollutant.

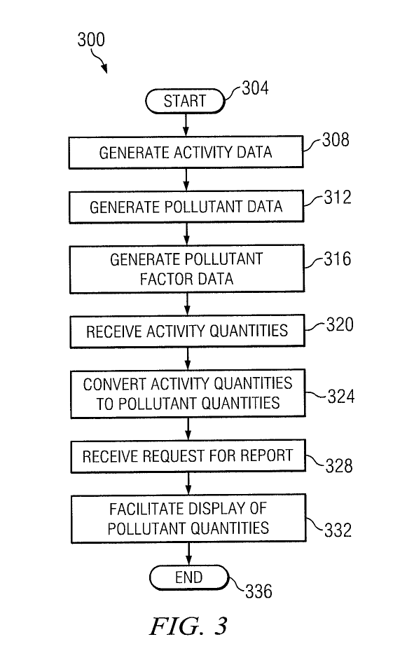

FIG. 3 depicts an example of a method for itemizing and reporting pollutants of activities. The method begins at step 304. At step 308, manager application 112 generates activity data, such as an activity type or other attribute of an activity. For example, manager application 112 may add one or more new activities to activity data 132 and associate a set of pollutants with each activity. At step 312, manager application 112 generates pollutant data 136, such as a pollutant type or other attribute of a pollutant. For example, manager application 112 may add one or more pollutants and/or GWPs to pollutant data 136. At step 316, manager application 112 generates pollutant factor data 134. For example, manager application 112 may add one or more pollutant factors to pollutant factor data 134.

At step 320, manager application 112 receives activity quantities. In some embodiments, these quantities may indicate amounts of one or more activities that are performed by an organization. At step 324, manager application 112 converts the activity quantities to pollutant quantities. For example, manager application 112 may calculate a mass and/or a CO2e of a pollutant that is released by a quantity of an activity by using appropriate pollutant factors. This step may be repeated for each pollutant released by the activities that are being reported.

At step 328, manager application 112 receives a request for a report. For example, a request may indicate one or more timespans, pollutants, activities, locations, or other suitable characteristics. Manager application 112 generates the requested report using the pollutant quantities calculated at step 324. At step 332, manager application 112 facilitates display of pollutant quantities. For example, manager application 112 may present the requested report to a user through GUI 140 or a computer printout. The method ends at step 336.

Modifications, additions, or omissions may be made to the systems and apparatuses disclosed herein without departing from the scope of the invention. The components of the systems and apparatuses may be integrated or separated. For example, one or more of activity data 132, activity objects 144, pollutant data 136, and pollutant factor data 134 may be integrated. As another example, a portion or all of one or more of activity data 132, pollutant data 136, and pollutant factor data 134 may be a subobject of activity data 132, pollutant data 136, and/or pollutant factor data 134. Moreover, the operations of the systems and apparatuses may be performed by more, fewer, or other components. For example, the operations of manager application 112 may be performed by more than one component. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The method may include more, fewer, or other steps. Additionally, steps may be performed in any suitable order.

A component of the systems and apparatuses disclosed herein may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program. In some embodiments, the computer readable media may be non-transitory.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising:
receiving a first quantity of an activity, the first quantity indicating an amount of the activity that is performed;
accessing a list of one or more pollutants that are released when the activity is performed;
selecting one or more pollutant factors, each pollutant factor associated with a pollutant of the one or more pollutants, each pollutant factor indicating an amount of the associated pollutant released when the activity is performed;
calculating one or more pollutant quantities of the one or more pollutants, a pollutant quantity of a pollutant calculated according to the first quantity of the performed activity and the pollutant factor associated with the pollutant; and
facilitating display of the one or more pollutant quantities.

2. The method of claim 1, further comprising:
receiving a second quantity of the activity; and
calculating a quantity of a pollutant released by the first quantity and the second quantity of the activity.

3. The method of claim 1, the calculating the one or more pollutant quantities further comprising:
calculating a quantity of a pollutant released by the first quantity of the performed activity and a second quantity of a second activity.

4. The method of claim 1, the pollutant factor also associated with one or more of an activity, a location, a time frame, and a review date.

5. The method of claim 1, the selecting one or more pollutant factors further comprising:
accessing a plurality of pollutant factors, each pollutant factor associated with the activity, a pollutant, and a location; and
selecting a pollutant factor from the plurality of pollutant factors according to the location associated with the pollutant factor.

6. The method of claim 1, a pollutant factor of a pollutant comprising an emission factor, the emission factor indicating:
a mass of the pollutant released per a unit of the activity; or
a carbon dioxide equivalent of the pollutant per a unit of the activity.

7. The method of claim 1, a pollutant factor of a pollutant comprising a global warming potential (GWP), the GWP indicating a carbon dioxide equivalent of the pollutant per a unit of mass of the pollutant.

8. A system, comprising:
one or more processors;
a memory that stores logic operable to:
receive a first quantity of an activity, the first quantity indicating an amount of the activity that is performed;
access a list of one or more pollutants that are released when the activity is performed;
select one or more pollutant factors, each pollutant factor associated with a pollutant of the one or more pollutants, each pollutant factor indicating an amount of the associated pollutant released when the activity is performed;
calculate one or more pollutant quantities of the one or more pollutants, a pollutant quantity of a pollutant calculated according to the first quantity of the performed activity and the pollutant factor associated with the pollutant; and
facilitate display of the one or more pollutant quantities.

9. The system of claim 8, the logic further operable to:
receive a second quantity of the activity; and
calculate a quantity of a pollutant released by the first quantity and the second quantity of the activity.

10. The system of claim 8, the calculating the one or more pollutant quantities further comprising:
calculating a quantity of a pollutant released by the first quantity of the performed activity and a second quantity of a second activity.

11. The system of claim 8, the pollutant factor also associated with one or more of an activity, a location, a time frame, and a review date.

12. The system of claim 8, the selecting one or more pollutant factors further comprising:
accessing a plurality of pollutant factors, each pollutant factor associated with the activity, a pollutant, and a location; and
selecting a pollutant factor from the plurality of pollutant factors according to the location associated with the pollutant factor.

13. The system of claim 8, a pollutant factor of a pollutant comprising an emission factor, the emission factor indicating:
a mass of the pollutant released per a unit of the activity; or
a carbon dioxide equivalent of the pollutant per a unit of the activity.

14. The system of claim 8, a pollutant factor of a pollutant comprising a global warming potential (GWP), the GWP indicating a carbon dioxide equivalent of the pollutant per a unit of mass of the pollutant.

15. One or more tangible non-transitory computer-readable media having computer-executable code, when executed by a computer operable to:
receive a first quantity of an activity, the first quantity indicating an amount of the activity that is performed;
access a list of one or more pollutants that are released when the activity is performed;
select one or more pollutant factors, each pollutant factor associated with a pollutant of the one or more pollutants, each pollutant factor indicating an amount of the associated pollutant released when the activity is performed;
calculate one or more pollutant quantities of the one or more pollutants, a pollutant quantity of a pollutant calculated according to the first quantity of the performed activity and the pollutant factor associated with the pollutant; and
facilitate display of the one or more pollutant quantities.

16. The media of claim 15, when executed further operable to:
receive a second quantity of the activity; and
calculate a quantity of a pollutant released by the first quantity and the second quantity of the activity.

17. The media of claim 15, the calculating the one or more pollutant quantities further comprising:
calculating a quantity of a pollutant released by the first quantity of the performed activity and a second quantity of a second activity.

18. The media of claim 15, the pollutant factor also associated with one or more of an activity, a location, a time frame, and a review date.

19. The media of claim 15, the selecting one or more pollutant factors further comprising:
accessing a plurality of pollutant factors, each pollutant factor associated with the activity, a pollutant, and a location; and
selecting a pollutant factor from the plurality of pollutant factors according to the location associated with the pollutant factor.

20. The media of claim 15, a pollutant factor of a pollutant comprising an emission factor, the emission factor indicating:
a mass of the pollutant released per a unit of the activity; or
a carbon dioxide equivalent of the pollutant per a unit of the activity.

21. The media of claim 15, a pollutant factor of a pollutant comprising a global warming potential (GWP), the GWP indicating a carbon dioxide equivalent of the pollutant per a unit of mass of the pollutant.
